(19) United States
(12) Patent Application Publication
(10) Pub. No.: US 2018/0112640 A1
(43) Pub. Date: Apr. 26, 2018

(54) NOZZLE PLATE FOR FUEL INJECTION DEVICE

(71) Applicant: ENPLAS CORPORATION, Saitama (JP)

(72) Inventor: Kazuma YANAGISAWA, Saitama (JP)

(21) Appl. No.: 15/573,645

(22) PCT Filed: May 11, 2016
(86) PCT No.: PCT/JP2016/063961

§ 371 Date: Nov. 13, 2017

(30) Foreign Application Priority Data
May 14, 2015 (JP) 2015-098682

(51) Int. Cl. F02M 61/18

(52) U.S. Cl. CPC F02M 61/1853

(57) ABSTRACT

A nozzle plate for a fuel injection device opposes a fuel injection port of a fuel injection device. A nozzle hole through which fuel injected from the fuel injection port passes is formed at the nozzle plate. At this nozzle plate for the fuel injection device, the nozzle hole has a fuel-flow-in-side opening end with a circular shape. The nozzle hole is coupled to the fuel injection port via fuel guide channels. The fuel guide channels have an opening into the nozzle hole, and a pair of opposing channel sidewalls. The opening has a channel width smaller than a hole diameter of the nozzle hole. One of the opposing channel sidewalls is formed to extend in a tangential direction of the nozzle hole. The fuel is directly flowed into the nozzle hole to generate a flow of the fuel in a spiral pattern in the nozzle hole.

### TECHNICAL FIELD

The present invention relates to a nozzle plate for a fuel injection device (hereinafter abbreviated as a nozzle plate as necessary), which is mounted on a fuel injection port of the fuel injection device, and injects fuel flowed out from the fuel injection port after atomizing the fuel.

### BACKGROUND ART

An internal combustion engine (hereinafter abbreviated as “engine”) of an automobile or the like is configured such that a combustible mixed gas is formed by mixing fuel injected from a fuel injection device and air introduced into the engine through an intake pipe, and the combustible mixed gas is burned in the inside of the cylinder. It has been known that, in such an engine, a mixing state of the fuel injected from the fuel injection device and the air largely influences the performance of the engine. Particularly, it has been known that the atomization of the fuel injected from the fuel injection device becomes an important factor, which influences the performance of the engine.

Such a fuel injection device, in order to ensure the atomization of the fuel in spraying, is configured such that a nozzle plate is mounted on a fuel injection port of a valve body to inject the fuel from a plurality of fine nozzle holes formed on this nozzle plate.

FIG. 11 and FIG. 12 show such conventional nozzle plates 100. At the nozzle plates 100 shown in these drawings, after fuel is supplied to swirl chambers 102 by fuel guide channels 101, the fuel supplied into the swirl chambers 102 turns in the swirl chambers 102, the fuel that has turned in these swirl chambers 102 flows into nozzle holes 103, the fuel that has flowed into these nozzle holes 103 flows in a spiral pattern in the nozzle holes 103 to be thin, and then, this thinned fuel is injected from the nozzle holes 103, thus atomizing fuel particles in spraying (see Patent Documents 1 and 2).

### PRIOR ART DOCUMENTS

### Patent Documents

Patent Document 1: Japanese Unexamined Patent Application Publication No. 2002-364496 (especially, FIG. 5)
Patent Document 2: Japanese Unexamined Patent Application Publication No. 2014-214682 (especially, FIG. 9)

### DISCLOSURE OF THE INVENTION

### Problems to be Solved by the Invention

However, at the conventional nozzle plates 100 shown in FIG. 11 and FIG. 12, since the fuel remains in the swirl chambers 102 and in the nozzle holes 103 after fuel injection, even if new fuel is supplied into the swirl chambers 102 at the start of the fuel injection, it takes time until when the fuel remained in the swirl chambers 102 and in the nozzle holes 103 has been sufficiently turned. Thus, the fuel that has not been sufficiently turned will be injected in an early stage of the fuel injection. Therefore, it has been known that at the conventional nozzle plates 100 shown in FIG. 11 and FIG. 12, variation in the size of the fuel particles in the spray generated in the early stage of the fuel injection occurs, and then, large droplets that are less likely to evaporate mix in the spray generated in the early stage of the fuel injection. Then, these large droplets, which are less likely to evaporate in the spray, attach to an intake air pipe and an inner wall of a cylinder to degrade fuel efficiency due to small velocity damping by air resistance.

Therefore, an object of the present invention is to provide a nozzle plate that uniforms sizes of fuel particles in spray in an early stage of fuel injection not to generate large droplets that are less likely to evaporate in the spray in the early stage of the fuel injection.

### Solutions to the Problems

The present invention relates to a nozzle plate for a fuel injection device 3 disposed opposed to a fuel injection port 5 of a fuel injection device 1. The nozzle plate 3 has a nozzle hole 6 through which fuel injected from the fuel injection port 5 passes. According to the present invention, the nozzle hole 6 has a fuel-flow-in-side opening end 6a whose shape is a circular shape. The nozzle hole 6 is coupled to the fuel injection port 5 via fuel guide channels 15 and 16. The fuel guide channels 15 and 16 each have an opening 20 to the nozzle hole 6, and a pair of opposing channel sidewalls 21 and 22. The opening 20 has a channel width smaller than a hole diameter of the nozzle hole 6. One (21) of the opposing channel sidewalls 21 and 22 is formed to extend in a tangential direction of the nozzle hole 6. The fuel is directly flowed into the nozzle hole 6 to generate a flow of the fuel in a spiral pattern in the nozzle hole 6.

### Effects of the Invention

Since at the nozzle plate according to the present invention, the fuel is directly flowed into the nozzle hole from the fuel guide channel to generate the flow of the fuel in the spiral pattern in the nozzle hole, the fuel that remains in the nozzle hole at the start of the fuel injection is easily turned, and the flow of the fuel injected from the nozzle hole can be thinned even in the early stage of the fuel injection. As a result, the nozzle plate according to the present invention can uniform the sizes of the fuel particles in the spray in the early stage of the fuel injection to prevent the large droplets that are less likely to evaporate from occurring in the spray in the early stage of the fuel injection.

### BRIEF DESCRIPTION OF THE DRAWINGS

FIG. 1 is a view schematically showing an in-use state of a fuel injection device on which a nozzle plate for a fuel injection device according to an embodiment of the present invention is mounted.

FIG. 2 are views showing the nozzle plate according to the embodiment of the present invention, FIG. 2A is a front view of the nozzle plate, FIG. 2B is a cross-sectional view of the nozzle plate taken along a line A1-A1 in FIG. 2A, and FIG. 2C is a back view of the nozzle plate.

FIG. 3A is an enlarged view of a part of the nozzle plate (a peripheral portion of the nozzle hole) shown in FIG. 2C, FIG. 3B is an enlarged view of a portion B1 in FIG. 3A, and FIG. 3C is a cross-sectional view of the nozzle plate taken along a line A2-A2 in FIG. 3A.

FIG. 4 are views showing a nozzle plate according to a first modification of the embodiment of the present invention, FIG. 4A is an enlarged view of a part of the nozzle plate (a peripheral portion of the nozzle hole) according to this modification, FIG. 4B is an enlarged view of a portion B2 in FIG. 4A, and FIG. 4C is a cross-sectional view of the nozzle plate taken along a line A3-A3 in FIG. 4A.

FIG. 5 is a view showing a nozzle plate according to a second modification of the embodiment of the present invention, and a view corresponding to FIG. 3B.

FIG. 6 is a view showing a nozzle plate according to a third modification of the embodiment of the present invention, and a view showing a modification of the nozzle plate according to the first modification.

FIG. 7 is a view showing a nozzle plate according to a fourth modification of the embodiment of the present invention, and a view corresponding to FIG. 3B.

FIG. 8 is a view showing a nozzle plate according to a fifth modification of the embodiment of the present invention, and a view corresponding to FIG. 3C.

FIG. 9 is a view showing a nozzle plate according to a sixth modification of the embodiment of the present invention, and a view corresponding to FIG. 3A.

FIG. 10 are views showing a nozzle plate according to a seventh modification of the embodiment of the present invention, FIG. 10A is a plan view of the nozzle plate, FIG. 10B is a cross-sectional view of the nozzle plate taken along a line A4-A4 in FIG. 10A, and FIG. 10C is a rear view of the nozzle plate.

FIG. 11 is a plan view of a nozzle plate according to a first conventional example.

FIG. 12 is a plan view of a nozzle plate according to a second conventional example.

### DESCRIPTION OF PREFERRED EMBODIMENTS

Embodiments of the present invention are described in detail by reference to drawings hereinafter.

### First Embodiment

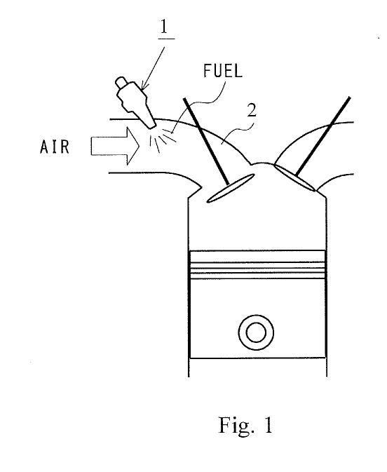

FIG. 1 is a view schematically showing an in-use state of a fuel injection device 1 on which a nozzle plate according to a first embodiment of the present invention is mounted. As shown in FIG. 1, the fuel injection device 1 of a port injection method is mounted in a middle portion of an intake pipe 2 of an engine, and is configured to generate a combustible mixed gas by injecting fuel into the inside of the intake pipe 2 and mixing air and the fuel introduced into the intake pipe 2.

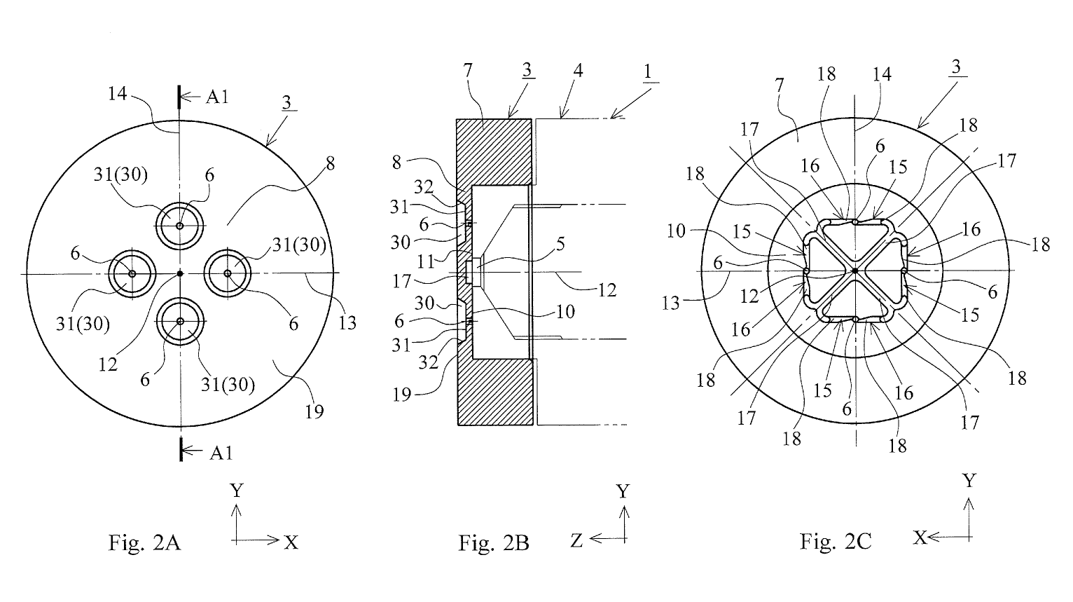

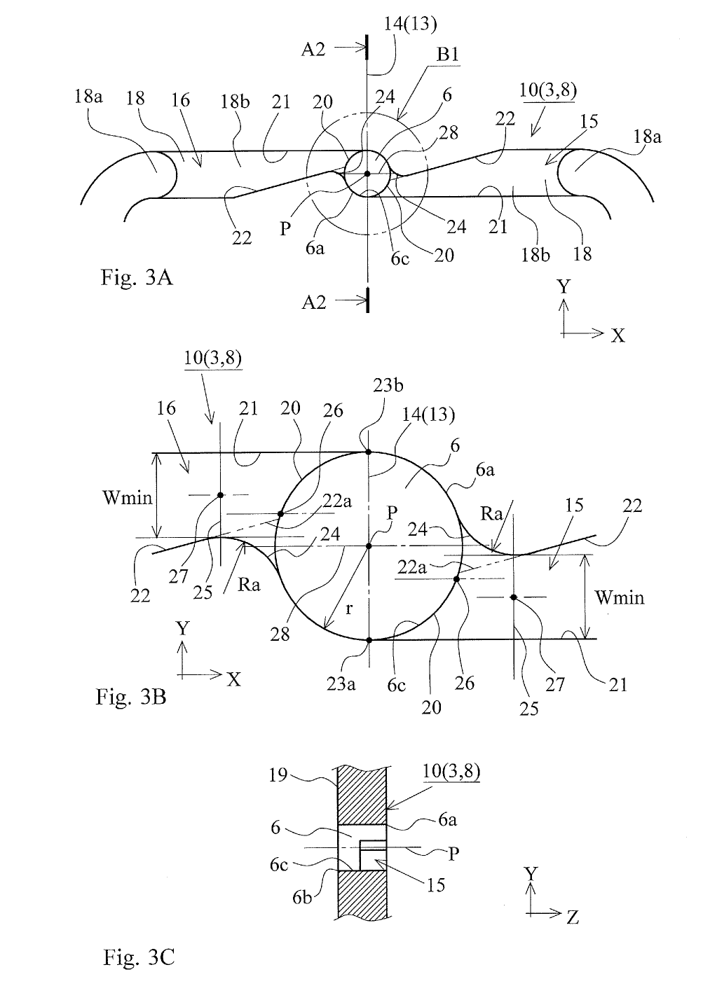

FIG. 2 to FIG. 3 are views showing a nozzle plate 3 according to the first embodiment of the present invention. FIG. 2A is a front view of the nozzle plate 3, FIG. 2B is a cross-sectional view of the nozzle plate 3 taken along a line A1-A1 in FIG. 2A, and FIG. 2C is a back view of the nozzle plate 3. FIG. 3A is an enlarged view of a part of the nozzle plate 3 (a peripheral portion of a nozzle hole 6) shown in FIG. 2C, FIG. 3B is an enlarged view of a portion B1 in FIG. 3A, and FIG. 3C is a cross-sectional view taken along a line A2-A2 in FIG. 3A.

As shown in FIG. 2, the nozzle plate 3, which is mounted on a distal end of a valve body 4 of the fuel injection device 1, is configured to spray the fuel injected from a fuel injection port 5 of the valve body 4 from a plurality of (four in this embodiment) nozzle holes 6 to a side of the intake pipe 2. This nozzle plate 3 is a bottomed cylindrical body made of a synthetic resin material (for example, PPS, PEEK, POM, PA, PES, PEI, and LCP) which is constituted of a circular cylindrical fitted portion 7 and a plate body portion 8 which is integrally formed with one end side of the circular cylindrical fitted portion 7. Then, the circular cylindrical fitted portion 7 of the nozzle plate 3 is fitted on an outer periphery of the valve body 4 on a distal end side without a gap, and is fixed to the valve body 4 in a state where an inner surface 10 of the plate body portion 8 is brought into contact with a distal end surface 11 of the valve body 4.

The plate body portion 8, which is formed into a circular-plate shape, has a central axis 12. On an identical circumference around the central axis 12, a plurality of (four) nozzle holes 6 are formed at regular intervals. This nozzle hole 6 is formed such that one end (a fuel-flow-in-side opening end) 6a opens at a side of the surface (inner surface) 10 opposed to the fuel injection port 5 of the plate body portion 8 and another end (a fuel-flow-out-side opening end) 6b opens at a side of an outer surface 19 (a surface positioned at a side opposed to the inner surface 10) of the plate body portion 8. The nozzle hole 6 has a true circle shape when the inner surface 10 of the plate body portion 8 is viewed in plan view. The nozzle holes 6 are formed in pairs on a first center line 13 that passes through the center of the plate body portion 8 and is parallel to an X-axis. And, the nozzle holes 6 are formed in pairs on a second center line 14 that passes through the center of the plate body portion 8 and is parallel to a Y-axis. Then, this nozzle hole 6 is coupled to the fuel injection port 5 of the valve body 4 via first and second fuel guide channels 15 and 16. Therefore, the fuel injected from the fuel injection port 5 is directly introduced into the nozzle hole 6 from the first and second fuel guide channels 15 and 16. At the nozzle hole 6, a shape of the fuel-flow-in-side opening end 6a is not limited to a true circle in a circular shape, and the shape of the fuel-flow-in-side opening end 6a may be an ellipse in a circular shape.

At the plate body portion 8, the first and second fuel guide channels 15 and 16 are formed at the inner surface 10 side. The first and second fuel guide channels 15 and 16 are formed of a radial-direction channel portion 17 and a branch channel portion 18. The radial-direction channel portion 17 extends from the center of the plate body portion 8 toward an outside in a radial direction. The branch channel portion 18 branches from an outside end in the radial direction of this radial-direction channel portion 17 to extend up to the nozzle holes 6. The radial-direction channel portion 17 is formed as positioned at the midpoint of a pair of the nozzle holes 6, 6 adjacent to one another. The radial-direction channel portion 17 is formed at four positions at regular intervals around the central axis 12 of the plate body portion 8. Then, one of the adjacent pair of nozzle holes 6, 6 is coupled to the radial-direction channel portion 17 via the branch channel portion 18 of the first fuel guide channel 15. The other of the adjacent pair of nozzle holes 6, 6 is coupled to the radial-direction channel portion 17 via the branch channel portion 18 of the second fuel guide channel 16. That is, the branch channel portion 18 of the first fuel guide channel 15 coupled to the one of the adjacent pair of nozzle holes 6, 6, and the branch channel portion 18 of the second fuel guide channel 16 coupled to the other of the adjacent pair of nozzle holes 6, 6 are formed by being biforked from the outside end in the radial direction of the common radial-direction channel portion 17. The branch channel portions 18 of the first fuel guide channels 15 and the branch channel portions 18 of the second fuel guide channels 16 are formed having numbers identical to the number of the radial-direction channel portions 17.

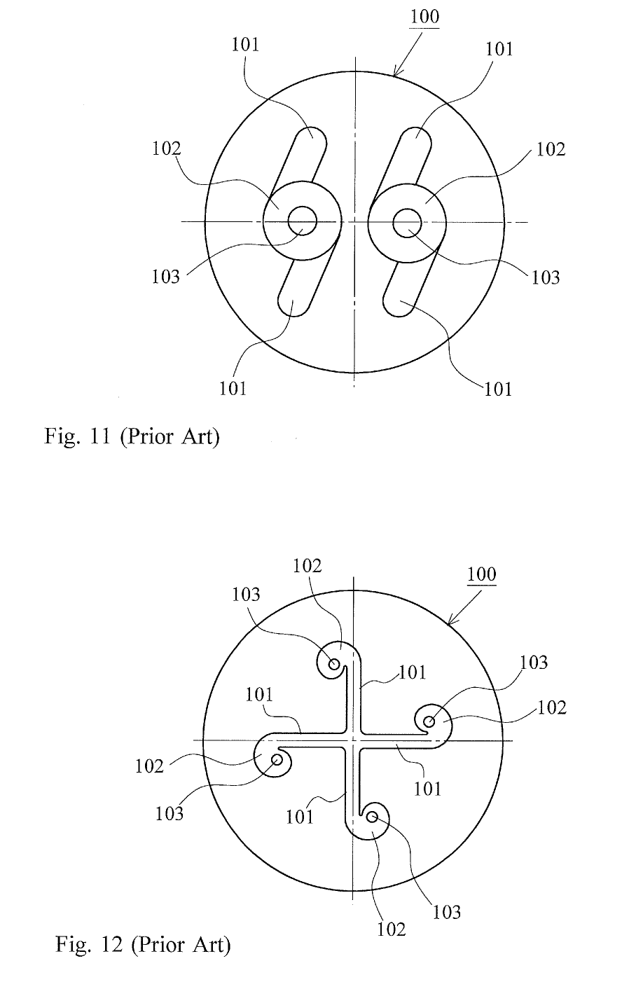

The branch channel portion 18 of the first fuel guide channel 15 extends in a direction perpendicular to the first center line 13 or the second center line 14 from the outside end in the radial direction of the radial-direction channel portion 17, and has a channel width of the opening 20 into the nozzle hole 6. This channel width is formed smaller than a diameter (2r) of the nozzle hole 6. Then, at the branch channel portion 18 of the first fuel guide channel 15, one (21) of a pair of opposing channel sidewalls 21 and 22 is coupled to a cross-point 23a to extend in a tangential direction of an inner surface 6c of the nozzle hole 6 (a direction parallel to the X-axis or a direction parallel to the Y-axis). The cross-point 23a is a cross-point between the fuel-flow-in-side opening end 6a of the nozzle hole 6, and the first center line 13 or the second center line 14, and is positioned at the inner side in the radial direction. At the branch channel portion 18 of the first fuel guide channel 15, a part at a proximity of the opening 20 into the nozzle hole 6 is formed to approach the one (21) of the pair of opposing channel sidewalls 21 and 22 (to gradually reduce the channel width) as the other (22) of the pair of opposing channel sidewalls 21 and 22 approaches the nozzle hole 6. And, the other (22) of the pair of opposing channel sidewalls 21 and 22 is smoothly coupled to the inner surface 6c of the nozzle hole 6 with a curved surface 24. Then, at the branch channel portion 18 of the first fuel guide channel 15, a minimum channel width part 25 is formed at the proximity of the opening 20 into the nozzle hole 6, and is formed such that a channel width of this minimum channel width part 25 (the narrowest channel width Wmin) is equal to or smaller than a radius r of the nozzle hole 6 (Wmin≤r). Thus, since the first fuel guide channel 15 can narrow a flow of the fuel at a proximity of the nozzle hole 6 to increase a flow velocity of the fuel, and can generate the flow along an inner peripheral surface of the nozzle hole 6, the first fuel guide channel 15 can promptly generate the flow in a spiral pattern in the nozzle hole 6, compare with conventional examples in FIG. 11 to FIG. 12.

The first fuel guide channel 15 has a center position 26 in a channel width direction at the opening 20. The center position 26 is positioned displaced off a center P of the nozzle hole 6. That is, in FIG. 3B, when assuming that a virtual straight line that passes through the center P of the nozzle hole 6 and is parallel to the one (21) of the pair of opposing channel sidewalls 21 and 22 is a first straight line 28, the center position 26 in the channel width direction at the opening 20 of the first fuel guide channel 15 is positioned between the one (21) of the pair of opposing channel sidewalls 21 and 22 and the first straight line 28.

The first fuel guide channel 15 has a center position 27 in a channel width direction at the minimum channel width part 25. The center position 27 is positioned displaced off the center P of the nozzle hole 6. That is, in FIG. 3B, the center position 27 in the channel width direction at the minimum channel width part 25 of the first fuel guide channel 15 is positioned between the one (21) of the pair of opposing channel sidewalls 21 and 22 and the first straight line 28.

The branch channel portion 18 of the second fuel guide channel 16 extends as being perpendicular to the first center line 13 or the second center line 14 from the outside end in the radial direction of the radial-direction channel portion 17, and has a channel width of the opening 20 into the nozzle hole 6. This channel width is formed smaller than the diameter of the nozzle hole 6. Then, at the branch channel portion 18 of the second fuel guide channel 16, the one (21) of the pair of opposing channel sidewalls 21 and 22 is coupled to a cross-point 23b to extend in the tangential direction of the inner surface 6c of the nozzle hole 6 (the direction parallel to the X-axis or the direction parallel to the Y-axis). The cross-point 23b is a cross-point between the fuel-flow-in-side opening end 6a of the nozzle hole 6, and the first center line 13 or the second center line 14, and is positioned at the outer side in the radial direction. At the branch channel portion 18 of the second fuel guide channel 16, a part at the proximity of the opening 20 into the nozzle hole 6 is formed to approach the one (21) of the pair of opposing channel sidewalls 21 and 22 (to gradually reduce the channel width) as the other (22) of the pair of opposing channel sidewalls 21 and 22 approaches the nozzle hole 6. And, the other (22) of the pair of opposing channel sidewalls 21 and 22 is smoothly coupled to the inner surface 6c of the nozzle hole 6 with the curved surface 24. Then, at the branch channel portion 18 of the second fuel guide channel 16, the minimum channel width part 25 is formed at the proximity of the opening 20 into the nozzle hole 6, and is formed such that the channel width of this minimum channel width part 25 (the narrowest channel width Wmin) is equal to or smaller than the radius r of the nozzle hole 6 (Wmin≤r). Then, this part at the proximity of the opening 20 into the nozzle hole 6 at the branch channel portion 18 of the second fuel guide channel 16 and the part at the proximity of the opening 20 into the nozzle hole 6 at the branch channel portion 18 of the first fuel guide channel 15 have a dyad symmetry shape around the center P of the nozzle hole 6. Thus, since the second fuel guide channel 16 can narrow the flow of the fuel at the proximity of the nozzle hole 6 to increase the flow velocity of the fuel, and can generate the flow along the inner peripheral surface of the nozzle hole 6, the second fuel guide channel 16 can promptly generate the flow in the spiral pattern in the nozzle hole 6, compare with the conventional examples in FIG. 11 to FIG. 12. The curved surfaces 24 of the first and second fuel guide channels 15 and 16 are configured to gradually increase the channel widths of the first and second fuel guide channels 15 and 16 as approaching the nozzle hole 6.

The second fuel guide channel 16 has the center position 26 in the channel width direction at the opening 20. The center position 26 is positioned displaced off the center P of the nozzle hole 6. That is, in FIG. 3B, the center position 26 in the channel width direction at the opening 20 of the second fuel guide channel 16 is positioned between the one (21) of the pair of opposing channel sidewalls 21 and 22 and the first straight line 28.

The second fuel guide channel 16 has the center position 27 in the channel width direction at the minimum channel width part 25. The center position 27 is positioned displaced off the center P of the nozzle hole 6. That is, in FIG. 3B, the center position 27 in the channel width direction at the minimum channel width part 25 of the second fuel guide channel 16 is positioned between the one (21) of the pair of opposing channel sidewalls 21 and 22 and the first straight line 28.

At the branch channel portion 18 of the first fuel guide channel 15 and the branch channel portion 18 of the second fuel guide channel 16, a part 18a nearer the radial-direction channel portion 17 is formed having a channel depth identical to a channel depth of the radial-direction channel portion 17, a part 18b nearer the nozzle hole 6 is formed shallower than the channel depth of the radial-direction channel portion 17, and the proximity of the opening 20 into the nozzle hole 6 is formed to narrow the channel width as approaching the nozzle hole 6. Thus, the branch channel portion 18 of the first fuel guide channel 15 and the branch channel portion 18 of the second fuel guide channel 16 can accelerate the flow of the fuel to lead the fuel into the nozzle hole 6. The part at the proximity of the opening 20 into the nozzle hole 6 at the branch channel portion 18 of the first fuel guide channel 15 and the part at the proximity of the opening 20 into the nozzle hole 6 at the branch channel portion 18 of the second fuel guide channel 16 are formed to approach the one (21) of the pair of opposing channel sidewalls 21 and 22 (to gradually reduce the channel width) as the other (22) of the pair of opposing channel sidewalls 21 and 22 approaches the nozzle hole 6. Thus, the part at the proximity of the opening 20 into the nozzle hole 6 at the branch channel portion 18 of the first fuel guide channel 15 and the part at the proximity of the opening 20 into the nozzle hole 6 at the branch channel portion 18 of the second fuel guide channel 16 can draw the flow of the fuel led into the nozzle hole 6, in a direction separating from the center P of the nozzle hole 6. The branch channel portion 18 of the first fuel guide channel 15 and the branch channel portion 18 of the second fuel guide channel 16 are formed such that the minimum channel width Wmin is equal to or smaller than the radius r of the nozzle hole (Wmin≤r) at the proximity of the opening 20 into the nozzle hole 6. Accordingly, the flow of the fuel flowed into the nozzle hole 6 from the first fuel guide channel 15 and the flow of the fuel flowed into the nozzle hole 6 from the second fuel guide channel 16 turn in an identical direction around the center P of the nozzle hole 6 without impinging. Thus, the fuel flowed into the nozzle hole 6 flows in the spiral pattern to become thin. The branch channel portions 18 of the first and second fuel guide channels 15 and 16 are formed such that a cross-sectional shape of a flow passage is a rectangular shape by the pair of opposing channel sidewalls 21 and 22 and a channel bottom.

At the side of the outer surface 19 of the plate body portion 8, bottomed recesses 30 that are concentric with centers P of the nozzle holes 6 are formed. This recess 30 is formed such that a bottom surface 31 has an outside diameter larger than that of the nozzle hole 6, and a taper-shaped inner surface 32 expands from the bottom surface 31 toward an outward of the bottomed recess 30. This recess 30 is formed such that the spray generated by injecting the fuel from the nozzle hole 6 does not impinge on the taper-shaped inner surface 32. The bottom surfaces 31 of the recesses 30 constitute a part of the outer surface 19 of the plate body portion 8.

As described above, since at the nozzle plate 3 according to the embodiment, the fuel is directly flowed into the nozzle hole 6 from the first and second fuel guide channels 15 and 16 to generate the flow of the fuel in the spiral pattern in the nozzle hole 6, the fuel that remains in the nozzle hole 6 at the start of the fuel injection is easily turned, and the flow of the fuel injected from the nozzle hole 6 can be thinned even in an early stage of the fuel injection. As a result, the nozzle plate 3 according to the embodiment can uniform sizes of fuel particles in the spray in the early stage of the fuel injection to prevent large droplets that are less likely to evaporate from occurring in the spray in the early stage of the fuel injection. Accordingly, the fuel injection device 1 that fixes the nozzle plate 3 according to the embodiment can contribute to improvement of fuel efficiency. At the conventional nozzle plates 100 shown in FIG. 11 to FIG. 12, the fuel in a resting state remains in the swirl chambers 102 and in the nozzle holes 103 at the start of the fuel injection. Thus, compared with the nozzle plate 3 according to the embodiment of the present invention, an amount of the remaining fuel in the resting state is large by volumes of the swirl chambers 102. As a result, compare with the nozzle plate 3 according to the embodiment of the present invention, the conventional nozzle plates 100 shown in FIG. 11 to FIG. 12 are hard to turn the fuel remaining in the nozzle hole 6 at the start of the fuel injection, and hard to thin the flow of the fuel injected from the nozzle hole 6 in the early stage of the fuel injection. Accordingly, the conventional nozzle plates 100 cannot uniform the sizes of the fuel particles in the spray in the early stage of the fuel injection. Thus, large droplets that are less likely to evaporate occur in the spray in the early stage of the fuel injection.

### First Modification

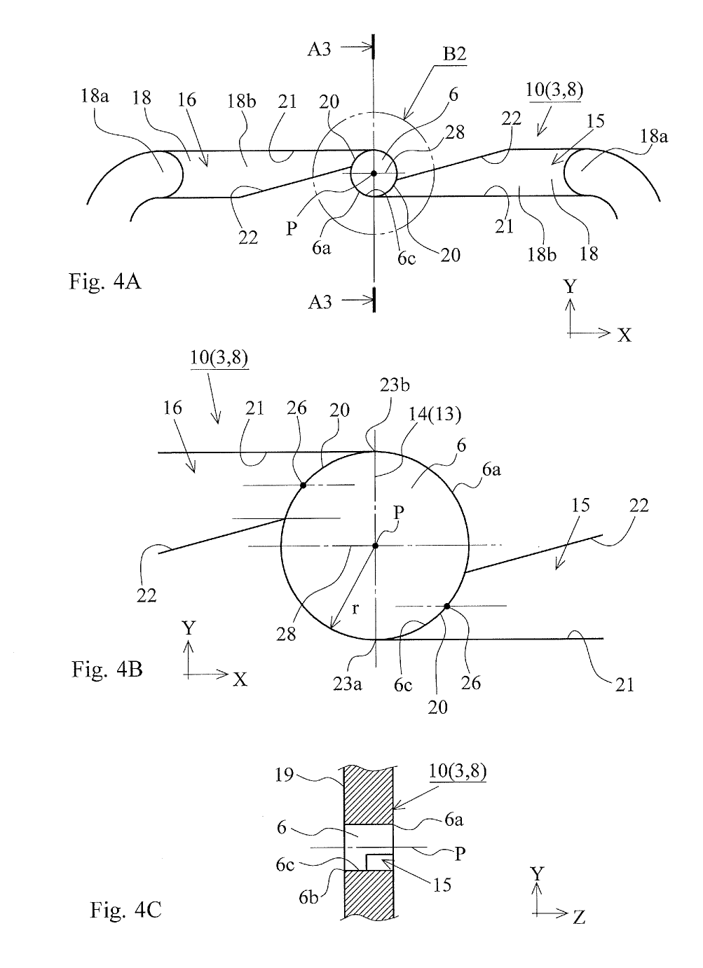

FIG. 4 are views showing a nozzle plate 3 according to a first modification of the above-described embodiment, and views corresponding to FIG. 3. FIG. 4A is an enlarged view of a part of the nozzle plate 3 (a peripheral portion of the nozzle hole 6) according to this modification, FIG. 4B is an enlarged view of a portion B2 in FIG. 4A, and FIG. 4C is a cross-sectional view of the nozzle plate 3 taken along a line A3-A3 in FIG. 4A.

As shown in FIG. 4, at the nozzle plate 3 according to this modification, the other (22) of the pair of opposing channel sidewalls 21 and 22 of the first and second fuel guide channels 15 and 16 is coupled to the nozzle hole 6 without forming the curved surface 24, unlike the nozzle plate 3 of the above-described embodiment where the other (22) of the pair of opposing channel sidewalls 21 and 22 of the first and second fuel guide channels 15 and 16 is smoothly coupled to the inner surface 6c of the nozzle hole 6 with the curved surface 24. That is, in this modification, at the first and second fuel guide channels 15 and 16, the other (22) of the pair of opposing channel sidewalls 21 and 22 is a tabular inclined wall formed to approach the one (21) of the pair of opposing channel sidewalls 21 and 22 as approaching the nozzle hole 6. This tabular inclined wall is directly coupled to the nozzle hole 6. In FIG. 3 showing the nozzle plate 3 according to the above-described embodiment, a part 22a indicated by the two-dot chain line of the first and second fuel guide channels 15 and 16 corresponds to a part (a part at the proximity of the nozzle hole 6) of the other (22) of the pair of opposing channel sidewalls 21 and 22 of the first and second fuel guide channels 15 and 16 in this modification.

As shown in FIG. 4, at the nozzle plate 3 according to this modification, the channel width of the opening 20 into the nozzle hole 6 of the first and second fuel guide channels 15 and 16 is smaller than a hole diameter of the nozzle hole 6, and the center position 26 in the channel width direction of the opening 20 is positioned between the one (21) of the pair of opposing channel sidewalls 21 and 22 and the first straight line 28. Moreover, at the first and second fuel guide channels 15 and 16, the other (22) of the pair of opposing channel sidewalls 21 and 22 is positioned between the one (21) of the pair of opposing channel sidewalls 21 and 22 and the first straight line 28, at the opening 20.

The nozzle plate 3 according to this modification as described above can obtain an effect similar to that of the nozzle plate 3 according to the above-described embodiment.

The nozzle plate 3 according to this modification, compare with the nozzle plate 3 according to the above-described embodiment, can more decrease the minimum channel widths of the first and second fuel guide channels 15 and 16, thus leading the fuel into the nozzle hole 6 in a state further effectively accelerated.

### Second Modification

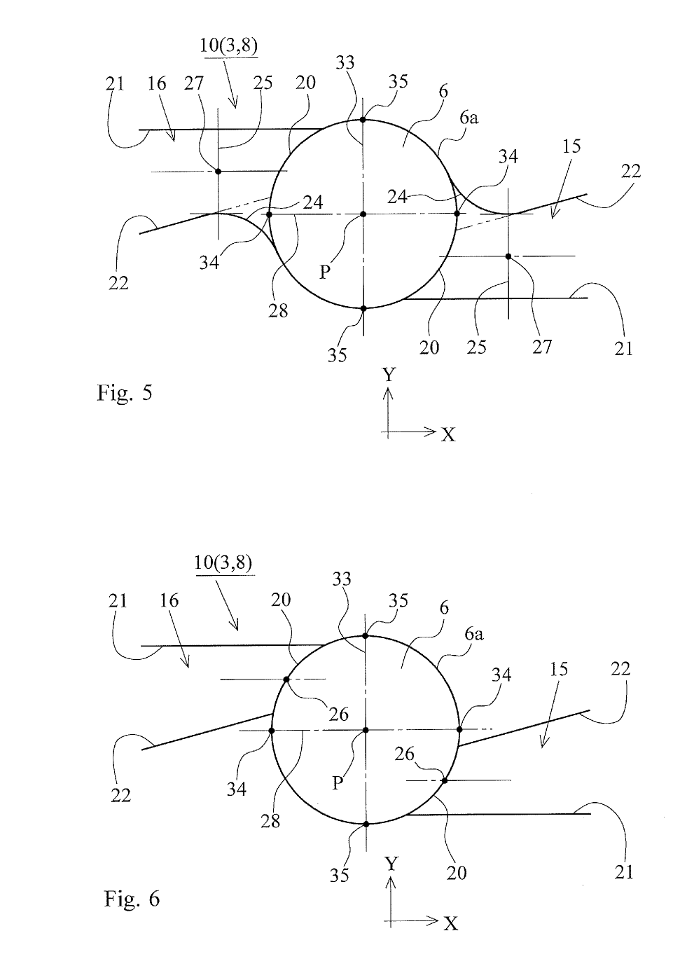

FIG. 5 is a view showing a nozzle plate 3 according to a second modification of the above-described embodiment, and a view corresponding to FIG. 3B.

As shown in FIG. 5, the nozzle plate 3 according to this modification has a structure that the openings 20 of the first and second fuel guide channels 15 and 16 of the nozzle plate 3 according to the above-described embodiment are shifted along the Y-axis direction to approach one another. That is, in FIG. 5 where the nozzle hole 3 is viewed in plan view, at the first and second fuel guide channels 15 and 16 of the nozzle plate 3 according to this modification, when assuming that a virtual straight line that passes through the center P of the nozzle hole 6 and is parallel to the one (21) of the pair of opposing channel sidewalls 21 and 22 is a first straight line 28, a virtual straight line that passes through the center P of the nozzle hole 6 and is perpendicular to the first straight line 28 is a second straight line 33, an intersection point between the fuel-flow-in-side opening end 6a of the nozzle hole 6 and the first straight line 28 is a first intersection point 34, and an intersection point between the fuel-flow-in-side opening end 6a of the nozzle hole 6 and the second straight line 33 is a second intersection point 35, a coupling position of the one (21) of the pair of opposing channel sidewalls 21 and 22 and the nozzle hole 6 is between the first intersection point 34 and the second intersection point 35, and the center position 27 in the channel width direction of the minimum channel width part 25 at the proximity of the opening 20 is positioned between the one (21) of the pair of opposing channel sidewalls 21 and 22 and the first intersection point 34. As shown in FIG. 5, at the first and second fuel guide channels 15 and 16, the other (22) of the pair of opposing channel sidewalls 21 and 22 at the minimum channel width part 25 at the proximity of the opening 20 is positioned on the first straight line 28 or between the one (21) of the pair of opposing channel sidewalls 21 and 22 and the first straight line 28, but is not limited to this. It is not necessary that the other (22) of the pair of opposing channel sidewalls 21 and 22 at the minimum channel width part 25 at the proximity of the opening 20 is positioned on the first straight line 28 or between the one (21) of the pair of opposing channel sidewalls 21 and 22 and the first straight line 28.

### Third Modification

FIG. 6 is a view showing a nozzle plate 3 according to a third modification of the above-described embodiment, and a view showing a modification of the nozzle plate 3 according to the above-described first modification. FIG. 6 is a view corresponding to FIG. 4B.

As shown in FIG. 6, the nozzle plate 3 according to this modification has a structure that the openings 20 of the first and second fuel guide channels 15 and 16 of the nozzle plate 3 according to the above-described first modification are shifted along the Y-axis direction to approach one another. That is, in FIG. 6 where the nozzle hole 6 is viewed in plan view, at the first and second fuel guide channels 15 and 16 of the nozzle plate 3 according to this modification, when assuming that an intersection point between the fuel-flow-in-side opening end 6a of the nozzle hole 6 and the first straight line 28 is a first intersection point 34, and an intersection point between the fuel-flow-in-side opening end 6a of the nozzle hole 6 and the second straight line 33 is a second intersection point 35, a coupling position of the one (21) of the pair of opposing channel sidewalls 21 and 22 and the nozzle hole 6 is between the first intersection point 34 and the second intersection point 35, and the center position 26 in the channel width direction of the opening 20 is positioned between the one (21) of the pair of opposing channel sidewalls 21 and 22 and the first intersection point 34. As shown in FIG. 6, at the first and second fuel guide channels 15 and 16, the other (22) of the pair of opposing channel sidewalls 21 and 22 is positioned between the one (21) of the pair of opposing channel sidewalls 21 and 22 and the first straight line 28, at the opening 20, but is not limited to this. It is not necessary that the other (22) of the pair of opposing channel sidewalls 21 and 22 is positioned between the one (21) of the pair of opposing channel sidewalls 21 and 22 and the first straight line 28.

### Fourth Modification

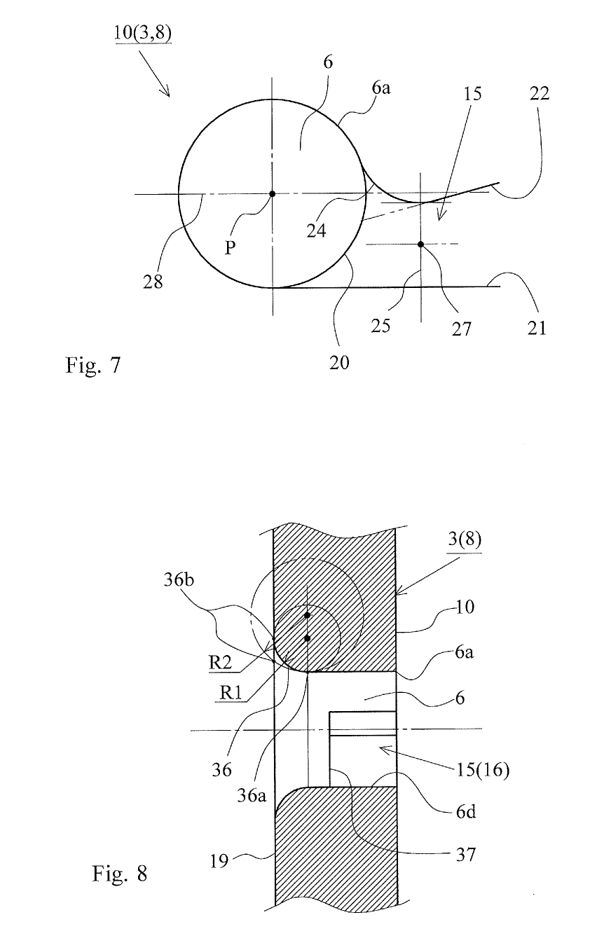

FIG. 7 is a view showing a nozzle plate 3 according to a fourth modification of the above-described embodiment, and a view corresponding to FIG. 3B.

The nozzle plate 3 according to this modification has a structure that omits the second fuel guide channel 16 at the nozzle plate 3 according to the above-described embodiment. That is, at the nozzle plate 3 according to this modification, a single fuel guide channel (the first fuel guide channel 15) opens at the nozzle hole 6. The nozzle plate 3 according to this modification may has a structure that omits the first fuel guide channel 15 of the first and second fuel guide channels 15 and 16 at the nozzle plate 3 according to the above-described embodiment.

As described above, since at the nozzle plate 3 according to this modification, the fuel can be directly flowed into the nozzle hole 6 from the single fuel guide channel (for example, the first fuel guide channel 15) to generate the flow of the fuel in the spiral pattern in the nozzle hole 6, the fuel that remains in the nozzle hole 3 at the start of the fuel injection is easily turned, and the flow of the fuel injected from the nozzle hole 3 can be thinned even in the early stage of the fuel injection. As a result, the nozzle plate 3 according to this modification can uniform the sizes of the fuel particles in the spray in the early stage of the fuel injection to prevent the large droplets that are less likely to evaporate from occurring in the spray in the early stage of the fuel injection. Accordingly, the fuel injection device 1 that fixes the nozzle plate 3 according to this modification can contribute to the improvement of the fuel efficiency.

### Fifth Modification

FIG. 8 is a view showing a nozzle plate 3 according to a fifth modification of the above-described embodiment, and a view corresponding to FIG. 3C.

At the nozzle plate 3 according to this modification, an inner surface at the fuel flow-out side of the nozzle hole 6 is a convex curved surface 36 that gradually increases a cross-sectional area of the flow passage toward a downstream side in a fuel flowing direction. This convex curved surface 36 has an end portion 36a at an upstream side in the fuel flowing direction. The end portion 36a is smoothly (without forming an edge) coupled to an inner peripheral surface of a circular hole part 6d of the nozzle hole 6. The convex curved surface 36 has an end portion 36b at the downstream side in the fuel flowing direction. The end portion 36b is smoothly coupled to the outer surface 19 of the plate body portion 8 (is formed having a curvature radius R1) or forms an edge with the outer surface 19 of the plate body portion 8 (is formed having a curvature radius R2 (R2>R1)). The coupling portion (36a) of the circular hole part 6d and the convex curved surface 36, of the nozzle hole 6 is between a channel bottom 37 of the first and second fuel guide channels 15 and 16 and the outer surface 19 of the plate body portion 8. Thus, the fuel flowed into the nozzle hole 6 from the first and second fuel guide channels 15 and 16 flows in the spiral pattern at the circular hole part 6d of the nozzle hole 6 between the channel bottom 37 and the convex curved surface 36 of the first and second fuel guide channels 15 and 16 to become thin. This flow in the spiral pattern is extended by flowing along the convex curved surface 36 with Coanda effect to further become thin.

### Sixth Modification

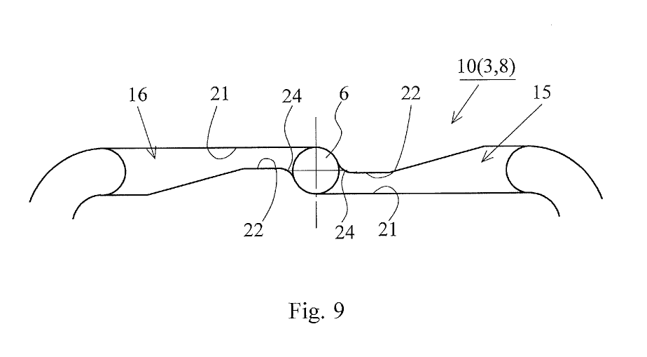

FIG. 9 is a view showing a nozzle plate 3 according to a sixth modification of the above-described embodiment, and a view corresponding to FIG. 3A.

At the nozzle plate 3 according to this modification, the pair of opposing channel sidewalls 21 and 22 of the first and second fuel guide channels 15 and 16 are formed parallel at the proximity of the nozzle hole 6, and the other (22) of the pair of opposing channel sidewalls 21 and 22 of the first and second fuel guide channels 15 and 16 is an inclined surface that separates from the one (21) of the pair of opposing channel sidewalls 21 and 22 as separating from the nozzle hole 6 at a position away from the nozzle hole 6. The nozzle plate 3 according to this modification is formed such that the minimum channel widths Wmin of the first and second fuel guide channels 15 and 16 have dimensions identical to dimensions of the minimum channel widths Wmin of the first and second fuel guide channels 15 and 16 according to the above-described embodiment. Such nozzle plate 3 according to this modification can obtain an effect similar to that of the nozzle plate 3 according to the above-described embodiment.

### Seventh Modification

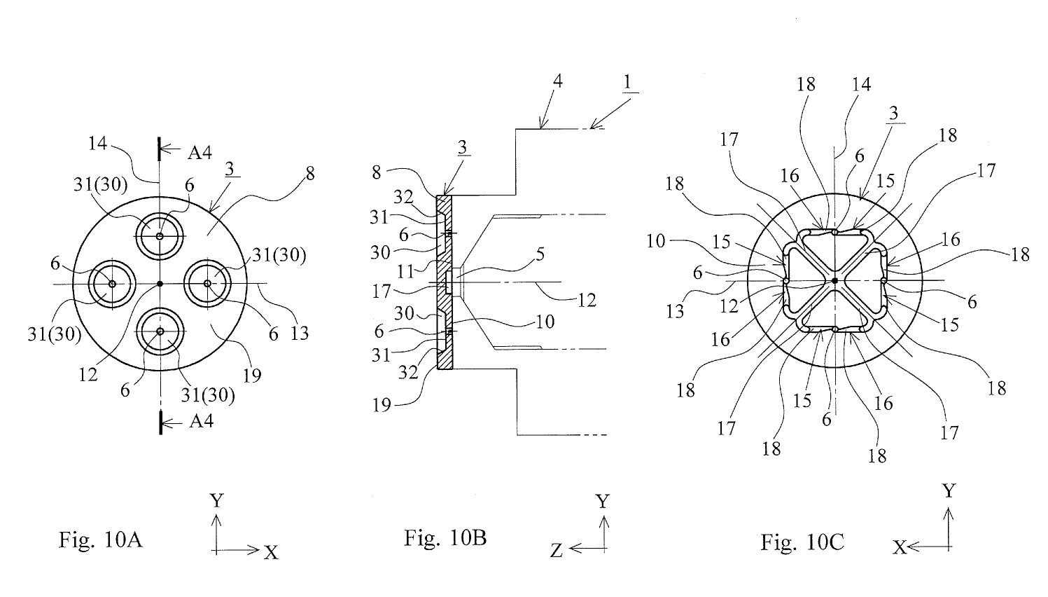

FIG. 10 are views showing a nozzle plate 3 according to a seventh modification of the above-described embodiment. FIG. 10A is a plan view of the nozzle plate 3, FIG. 10B is a cross-sectional view of the nozzle plate 3 taken along a line A4-A4 in FIG. 10A, and FIG. 10C is a rear view of the nozzle plate 3. At the nozzle plate 3 of this modification, identical reference numerals are attached to configuration parts identical to those of the nozzle plate 3 according to the above-described embodiment, and therefore the following omits the explanation overlapping the explanation of the nozzle plate 3 according to the above-described embodiment.

As shown in FIG. 10, the nozzle plate 3 according to this modification has a shape where the circular cylindrical fitted portion 7 of the nozzle plate 3 according to the above-described embodiment is omitted, and is constituted of only a part corresponding to the plate body portion 8 of the nozzle plate 3 according to the above-described embodiment. Other configuration of the nozzle plate 3 according to this modification is similar to that of the nozzle plate 3 according to the above-described embodiment. That is, at the nozzle plate 3 according to this modification, configurations of the nozzle hole 6, and the first and second fuel guide channels 15 and 16 are similar to those of the nozzle plate 3 according to the above-described embodiment. The nozzle plate 3 according to this modification, similarly to the nozzle plate 3 according to the above-described embodiment, is fixed to the valve body 4 in a state where the inner surface 10 of the plate body portion 8 is brought into contact with the distal end surface 11 of the valve body 4. Such nozzle plate 3 according to this modification can obtain an effect similar to that of the nozzle plate 3 according to the above-described embodiment. The nozzle plate 3 has an outer shape deformed as necessary corresponding to a shape at a distal end side of the valve body 4.

### Other Modifications

The nozzle plates 3 according to the above-described embodiment and the above-described respective modifications have exemplified an aspect where the nozzle holes 6 are formed at four positions at regular intervals around the center of the plate body portion 8, but are not limited to this. The nozzle holes 6 may be formed at a plurality of positions equal to or more than two positions at regular intervals around the center of the plate body portion 8.

The nozzle plates 3 according to the above-described embodiment and the above-described respective modifications may form a plurality of nozzle holes 6 at irregular intervals around the center of the plate body portion 8.

The nozzle plates 3 according to the above-described embodiment and the above-described respective modifications are mainly formed by the injection molding, but are not limited to this. The nozzle plate 3 may be formed such that a cutting work or the like is performed to a metal, and may be formed by using a metal injection molding method.

### DESCRIPTION OF REFERENCE SIGNS

1: Fuel injection device
3: Nozzle plate (nozzle plate for fuel injection device)
5: Fuel injection port
6: Nozzle hole
6a: Fuel-flow-in-side opening end
15: First fuel guide channel
16: Second fuel guide channel
20: Opening
21: Channel sidewall (one of a pair of opposing channel sidewalls)
22: Channel sidewall (the other of a pair of opposing channel sidewalls)

1. A nozzle plate for a fuel injection device disposed opposed to a fuel injection port of the fuel injection device, the nozzle plate having comprising a nozzle hole through which fuel injected from the fuel injection port passes, wherein:
the nozzle hole has a fuel-flow-in-side opening end whose shape is a circular shape, and the nozzle hole is coupled to the fuel injection port via a fuel guide channel, and
the fuel guide channel has an opening into the nozzle hole and a pair of opposing channel sidewalls, the opening has a channel width smaller than a hole diameter of the nozzle hole, one of the pair of opposing channel sidewalls is formed to extend in a tangential direction of the nozzle hole, and the fuel guide channel directly flows the fuel into the nozzle hole to generate a flow of the fuel in a spiral pattern in the nozzle hole.

2. A nozzle plate for a fuel injection device disposed opposed to a fuel injection port of the fuel injection device, the nozzle plate having a nozzle hole through which fuel injected from the fuel injection port passes, wherein:
the nozzle hole has a fuel-flow-in-side opening end whose shape is a circular shape, and the nozzle hole is coupled to the fuel injection port via a fuel guide channel, and the fuel guide channel:
has an opening into the nozzle hole, the opening is formed to have a channel width smaller than a hole diameter of the nozzle hole;
has formed such that, in a state where the nozzle hole is viewed in plan view, when assuming that a virtual straight line that passes through a center of the nozzle hole and is parallel to one of a pair of opposing channel sidewalls is a first straight line, a virtual straight line that passes through the center of the nozzle hole and is perpendicular to the first straight line is a second straight line, an intersection point between the first straight line and the fuel-flow-in-side opening end of the nozzle hole is a first intersection point, and an intersection point between the second straight line and the fuel-flow-in-side opening end of the nozzle hole is a second intersection point, a coupling position of the one of the pair of opposing channel sidewalls and the nozzle hole is positioned between the first intersection point and the second intersection point, and a center position in a direction of the channel width of the opening is positioned between the one of the pair of opposing channel sidewalls and the first intersection point; and
directly flows the fuel into the nozzle hole to generate a flow of the fuel in a spiral pattern in the nozzle hole.

3. A nozzle plate for a fuel injection device disposed opposed to a fuel injection port of the fuel injection device, the nozzle plate having a nozzle hole through which fuel injected from the fuel injection port passes, wherein:
the nozzle hole has a fuel-flow-in-side opening end whose shape is a circular shape, and the nozzle hole is coupled to the fuel injection port via a fuel guide channel, and
the fuel guide channel:
has an opening into the nozzle hole, the opening is formed to have a channel width smaller than a hole diameter of the nozzle hole;
has formed such that, in a state where the nozzle hole is viewed in plan view, when assuming that a virtual straight line that passes through a center of the nozzle hole and is parallel to one of a pair of opposing channel sidewalls is a first straight line, a virtual straight line that passes through the center of the nozzle hole and is perpendicular to the first straight line is a second straight line, an intersection point between the first straight line and the fuel-flow-in-side opening end of the nozzle hole is a first intersection point, and an intersection point between the second straight line and the fuel-flow-in-side opening end of the nozzle hole is a second intersection point, a coupling position of the one of the pair of opposing channel sidewalls and the nozzle hole is positioned between the first intersection point and the second intersection point, and a center position in a channel width direction at a minimum channel width part at a proximity of the opening is positioned between the one of the pair of opposing channel sidewalls and the first intersection point; and
directly flows the fuel into the nozzle hole to generate a flow of the fuel in a spiral pattern in the nozzle hole.

4. The nozzle plate for the fuel injection device according to claim 1, wherein the opening has a center position in a channel width direction, and the center position is positioned between a virtual straight line that passes through a center of the nozzle hole and is parallel to the one of the pair of opposing channel sidewalls and the one of the pair of opposing channel sidewalls.

5. The nozzle plate for the fuel injection device according to claim 1, wherein
a center position in a channel width direction at a minimum channel width part at a proximity of the opening is positioned between a virtual straight line that passes through a center of the nozzle hole and is parallel to the one of the pair of opposing channel sidewalls and the one of the pair of opposing channel sidewalls.

6. The nozzle plate for the fuel injection device according to claim 1, wherein
a proximity of the opening of the fuel guide channel is formed such that the other of the pair of opposing channel sidewalls approaches the one of the pair of opposing channel sidewalls as approaching the nozzle hole.

7. The nozzle plate for the fuel injection device according to claim 1, wherein:
the other of the pair of opposing channel sidewalls is smoothly coupled to an inner surface of the nozzle hole with a curved surface, and
the curved surface gradually increases a channel width of the fuel guide channel as approaching the nozzle hole.

8. The nozzle plate for the fuel injection device according to claim 2, wherein
a coupling position of the other of the pair of opposing channel sidewalls and the nozzle hole is between the one of the pair of opposing channel sidewalls and the first intersection point.

9. The nozzle plate for the fuel injection device according to claim 4, wherein
a coupling position of the other of the pair of opposing channel sidewalls and the nozzle hole is between the one of the pair of opposing channel sidewalls and the virtual straight line.

10. The nozzle plate for the fuel injection device according to any one claim 1, wherein
the opening of the fuel guide channel is formed to be dyad symmetry around a center of the nozzle hole.

11. The nozzle plate for the fuel injection device according to claim 1, wherein:
the nozzle hole has an inner surface at a fuel flow-out side, and the inner surface is a convex curved surface that gradually increases a cross-sectional area of a flow passage toward a downstream side in a fuel flowing direction, and
the convex curved surface is smoothly coupled to an inner surface at an upstream side in the fuel flowing direction of the nozzle hole.
